(19) United States
(12) Patent Application Publication
(10) Pub. No.: US 2016/0167940 A1
(43) Pub. Date: Jun. 16, 2016

(54) Apparatus and Method for DEF Tank Filling

(71) Applicant: Sean J. O'Rourke, Del Mar, CA (US)

(72) Inventor: Sean J. O'Rourke, Del Mar, CA (US)

(21) Appl. No.: 14/965,686

(22) Filed: Dec. 10, 2015

Related U.S. Application Data
(60) Provisional application No. 62/090,263, filed on Dec. 10, 2014.

(51) Int. Cl. B67D 7/02; B67D 7/58; B67D 7/38; F01N 3/20

(52) U.S. Cl. CPC B67D 7/0294; F01N 3/2066; B67D 7/58; B67D 7/38

(57) ABSTRACT

A refill device for a diesel exhaust fluid tank is provided which employs a nozzle connection to the fluid tank to provide replenishment of the exhaust fluid from a reservoir. Fluid from the reservoir is communicated to the fluid tank using a pump providing a pressurized fluid supply through a first hose. A second hose engaged with the nozzle vents air from the fluid tank for the duration of filling by the first hose.

### BACKGROUND OF THE INVENTION

1. Field of the Invention

This application claims priority to U.S. Provisional Patent Application Ser. No. 62/090,263 filed on Dec. 10, 2014.

The present invention relates to fueling of diesel vehicles. More particularly, it relates to a device and method employed for refilling the Diesel Exhaust Fluid (DEF) tank which has become a required component of modern emission-controlled diesel engines to meet emission standards.

2. Prior Art

Diesel engines have been a very efficient power provider for vehicles since the dawn of the automobile. Such engines are extremely efficient when compared to gasoline engines and have for decades provided excellent reliability.

The high mileage of diesel engines has to do primarily with the fuel itself, and with the design and function of such engines. Diesel fuel has in each gallon of fuel, more energy than gasoline. Thus, the employment of diesel fuel in an internal combustion engine, yields more power during combustion and thus more horsepower to the diesel engine than a gallon of gasoline provides to an internal combustion gasoline engine.

The other main reason for the increased efficiency of diesel engines, other than the fuel itself, is the manner of inducing combustion in diesel engines versus that of gasoline engines. In a gasoline engine fuel is communicated into a cylinder and during a compression stroke of the piston in that cylinder, a spark is induced to the cylinder to cause combustion. Because of the spark induced combustion, which occurs at a top end of the cylinder and proceeds to the opposite end, in a great many engines, not all of the fuel is combusted.

In a diesel engine, during a compression stroke of the piston in a cylinder, the piston proceeds to reduce the effective size of the cylinder which increases the pressure in the declining volume of the cylinder. At a point of peak compression in the cylinder extremely high heat in the cylinder caused by the high pressure itself causes the diesel fuel to combust and drive the piston in the opposite direction. Because of this pressure-induced combustion, and the higher energy level of the fuel itself, a more complete burring of the fuel is accomplished which in itself provides more efficient powering of the diesel engine.

Unfortunately in years past, diesel engines have had a problem with the exhaust emitted by the engine after the pressure-induced combustion. In addition to particulate matter exhausted, such engines also exhaust high levels of nitric oxide and nitrogen dioxide into the atmosphere. These exhausted gases are produced from the reaction of nitrogen and oxygen gases in the air provided to the combustion cylinder which is combined with the diesel fuel during combustion. When such combustion occurs, especially at high pressure and temperatures caused by the diesel compression ignition, particulate matter is exhausted, along with the noted high levels of nitric oxide and nitrogen dioxide, as a product of the combustion cycle.

Until recent years, the solution to emissions of the particulate or soot and the nitric oxide and nitrogen dioxide and other exhaust contents of diesel engines, have been sought in the area of the formulation of the fuel itself. Ever more stringent regulations on sulfur content of diesel fuel sold were advanced in attempts to address the problem. However, even with these efforts the high levels of nitric oxide and nitrogen dioxide in diesel exhaust needed to be lowered even further. This is due to new clean air regulations in the U.S. and many countries.

In the recent past, a solution has been found by auto manufacturers which employs Diesel exhaust fluid (DEF) which is piped from a separate DEF tank and then injected into the exhaust pipeline of the diesel engine to thereby mix with the exhausting gases. The DEF fluid contains primarily urea and water. This mixture of aqueous urea, when injected into the high heat of the exhaust manifold, vaporizes and decomposes to form ammonia and carbon dioxide.

Downstream from this injection point in the exhaust system, within the SCR catalyst, the mixture of nitric oxide and nitrogen dioxide (NOx) exhausted during engine combustion are catalytically reduced by the formed ammonia (NH3) from the DEF injection, into water (H2O) and nitrogen (N2). This results in an exhaust from the vehicle or engine in which the NOx emissions are rendered harmless.

However, due to the recent addition of such DEF tanks to vehicles, a problem has arisen for both motorists and vehicle service establishments. The DEF fluid must be constantly refilled to the DEF tank which is best filled to the brim leaving little free space in the tank. This is because the DEF fluid itself, due to the high levels of urea mixed with water, tends to crystallize when left exposed to the air. Additionally, the container providing the refill to the DEF tank, employs two hoses such that the tank can be refilled to the brim quickly. One hose fills the tank and a second hose vents the tank of air as the tank fills to allow it to fully fill.

However, containers for such refills, usable by motorists and service establishments alike have not addressed this two-hose requirement well. Additionally, even when addressed with two hoses, the current hoses used for filling DEF tanks, make no provision to prevent air from reaching the reservoir of DEF fluid in the hose, the refill container or the tank. Thus, subsequent to each refill of a DEF tank, crystals tend to form in both the refill hose and the return hose, as well as in the reservoir if air flows freely through the hoses. These crystals can block the flow in the hoses, or they can be carried by fluid flow during refilling into the DEF tank.

Further, such crystals, in some cases, will dissolve during filling of the DEF tank into the fluid. This addition of the urea in the crystals can change the percentage by volume of urea in the overall mixture in the fluid being used. Such is not desirable as increased urea by volume in the fluid injected to the exhaust system can change the reaction during such injection. Still, further available refill containers and refill tanks are cumbersome and slow.

As such, there is a continuing unmet need for an improved DEF replenishment device and method for modern vehicles employing DEF fluid supplied by a refillable onboard reservoir. Such a device should be easy to employ by both motorist or professional service technician. Such a device should provide for quick refills of the DEF tank, while concurrently preventing overfills which can damage the tank and spread the noxious fluid onto the vehicle surrounding the DEF tank.

Still further, such a device and method should employ both a filling hose and a venting hose, in a configuration adapted to engage with a DEF tank, in a manner which provides a means to prevent crystallization of the urea in the DEF fluid in the hoses and refill and which can impair fluid communication through the hoses as well as cause contamination of subsequent DEF fluid refills.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device and method herein disclosed and described achieves the abovementioned goals through the provision of a DEF fluid refilling system and method. The device features a pair of hoses running to a dispensing nozzle end. The nozzle end is configured for cooperative operative engagement with the refill opening on a conventional DEF fluid reservoir on a diesel fueled vehicle.

As depicted herein the device includes two hoses adapted to engage either a large drum reservoir used for a refill of the smaller DEF tank on the vehicle or as an engageable component to a bottle or tank of DEF fluid sold in auto stores for use by consumers to refill their DEF fluid on their vehicles. The device includes both hoses in a manner adapted to engage the reservoir of fluid with first ends of both hoses operatively positioned within the reservoir, and second ends of both hosed operatively engaged at nozzle.

In a first mode, the device includes a first hose communicating from a dispensing nozzle end to an opposite end in communication with a fluid pumped from the tank or bottle of DEF. Such pumping can be, for example, accomplished with a pump which is submersed in a tank or bottle of the DEF fluid used for refill. In the case of a bottle, a mechanical pump might be employed such as by depressing the nozzle to pump fluid.

A second hose in this first mode communicates from a receiving end located in an off-center positioning within the passage of the first hose at the nozzle end, to a dispensing end. The dispensing end is in sealed communication with a conduit or tube descending into the refill container.

In all modes, where a powered pump is employed, an electric pump is positioned within the reservoir providing the DEF fluid for the refill. Such a reservoir may be a large metal drum with gallons of fluid therein, or a smaller bottle of for example a gallon or few quarts of the DEF fluid used for refill.

The pump, when an electric pump is employed, is powered by low voltage electrical current which can be provided by a transformer plugged into an AC outlet for commercial use with large drums, or may be provided by a communication of vehicle battery power, such as using a plug to the 12 volt DC cigarette lighter recess located in most vehicles.

During use, the user engages the nozzle end to an operative engagement of the first hose within the larger refill aperture of a DEF tank. The smaller hose is concurrently engaged with the smaller off-center venting aperture of the DEF tank by its positioning in the nozzle.

Once engaged to this as-used position, power is switched to power the pump whereafter DEF fluid is pumped from the reservoir tank or bottle through, the first hose and into the DEF tank.

Particularly preferred in all modes of the device, the second hose is engaged to provide a sealed pathway for air to escape from the DEF tank during refill. This decreases the time required for the tank to fill by removing back pressure to the first hose connection. Further, by engaging the first hose to fill and engaging the second hose in a sealed relation to the DEF tank to vent, spillage is eliminated or significantly decreased.

In a second mode of the device, the configuration of hoses remains substantially the same. However, the operation is enhanced using a biased one-way valve positioned adjacent the dispensing end of the first hose and in the second hose adjacent to the engagement of the second hose to the venting aperture of the DEF tank. The one-way valve in the first hose provides a means to prevent back flow of the DEF fluid from the nozzle end to the tank.

Additionally the location of the biased or spring-loaded one way valves adjacent both the dispensing end of the first hose and the of the second hose adjacent the engagement to the venting aperture, prevents the communication of ambient air, to the interior of both hoses, and the interior of the container housing the refill supply of DEF. Such is most important to prevent the forming of crystals in the hoses and the reservoir of DEF which occurs should ambient air communicated with the fluid sufficient to evaporate the water therefrom.

Additionally desirable in all modes of the device, would be a fluid sensor in operative engagement with the second hose providing the venting of the DEF tank and a return of any overflow fluid therefrom. The fluid sensor can be mechanical or electronic and once a communication of fluid is sensed as passing into the venting second hose, the senor will emit a signal to cause the immediate cessation of electrical energy to the pump. Such will result in the cessation of pumping of fluid through the first hose to the DEF tank.

Such sensing to automatically cease fluid dispensing is desirable to render the device to automatically shut off to avoid any problems with fluid being pumped into the DEF tank which might cause a rupture. Further, automatic cessation of fluid dispensing renders the device usable by the general public driver who may not have the skills to ascertain when the DEF tank is full.

With respect to the above description, before explaining at least one preferred embodiment of the herein disclosed DEF tank refill system in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this DEF refill system disclosure is based, may readily be utilized as a basis for designing of other DEF refill systems, methods and systems for carrying out the several purposes of the present disclosed device. It is important, therefore, that the claims be regarded as including such equivalent construction and methodology insofar as they do not depart from the spirit and scope of the present invention.

It is one principal object of this invention to provide an easy to use DEF fluid refill system.

It is an additional object of this invention to provide such system which is usable by professionals and drivers alike and provides a means to prevent air flow to the DEF filling hoses and fluid reservoir and in some modes automatic shut off.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF DRAWING FIGURES

FIG. 1 depicts the DEF fluid refill reservoir having a pump communicating with a first tube used for fluid refill and having a second or venting tube communicating therein.

FIG. 2 depicts a nozzle end of the device showing the registered positioning of the first and second tubes, and also showing a preferred one-way flow valve situated adjacent the distal end of both tubes along with an optional but a preferred sensor on the second tube adjacent the one way valve.

FIG. 3 shows a typical opening for a DEF tank having openings communicating with conduits leading to the DEF tank.

FIG. 4 depicts a mode of the device wherein the second hose employed for venting runs within the first hose for the entire length outside the tank or reservoir.

FIG. 5 depicts a mode of the nozzle end wherein the hose configuration of FIG. 4 terminates at the nozzle end.

FIG. 6 depicts a typical mode of the device used commercially with a larger volume tank and onboard power supply.

FIG. 7 shows a mode of the device engaged with a larger or smaller reservoir such as a bottle, employing the hose connections of FIGS. 1 and 2, and having an electric connector for the provision of electrical power to the pump from a DC power supply or vehicle connection or AC connected transformer.

### DETAILED DESCRIPTION OF THE PREFERRED EMBODIMENTS OF THE INVENTION

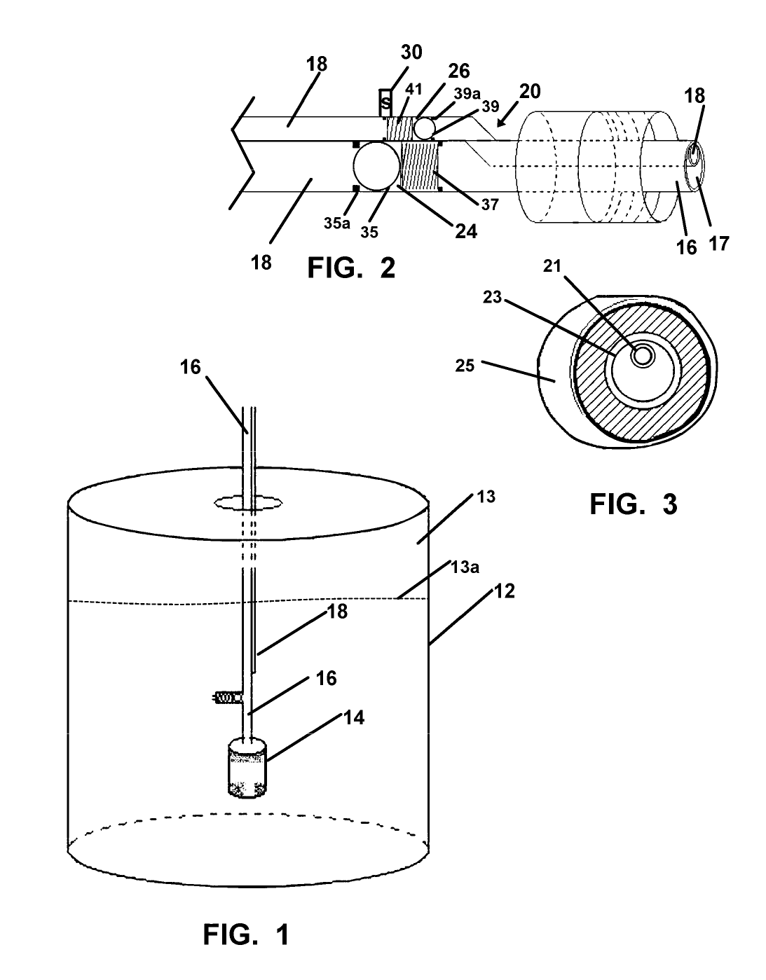

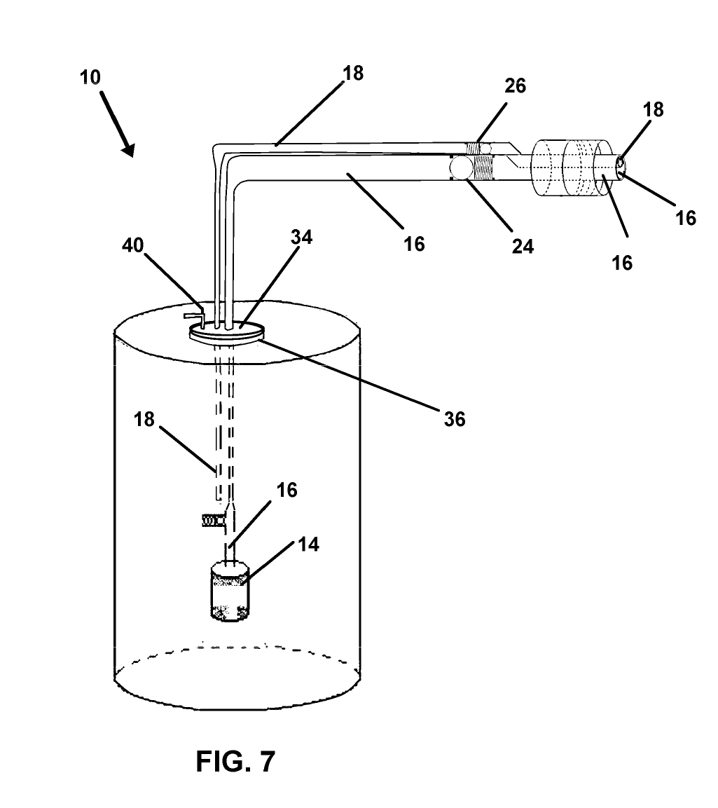

Referring now to the drawings of FIGS. 1-7 depicting the various modes of the refill device 10, which is shown configured in an as-used position in FIG. 7.

Shown in FIG. 1, the device 10 in all modes includes a DEF fluid refill reservoir 12 having an interior cavity 13 which is filled with a supply of DEF fluid 13a therein. A mechanical or the shown electric pump 14 is placed in operative communication with the DEF fluid 13a, and pumps a pressurized fluid supply to the first end of an operatively engaged first tube 16 or conduit, which is employed for refilling a DEF tank on a diesel vehicle.

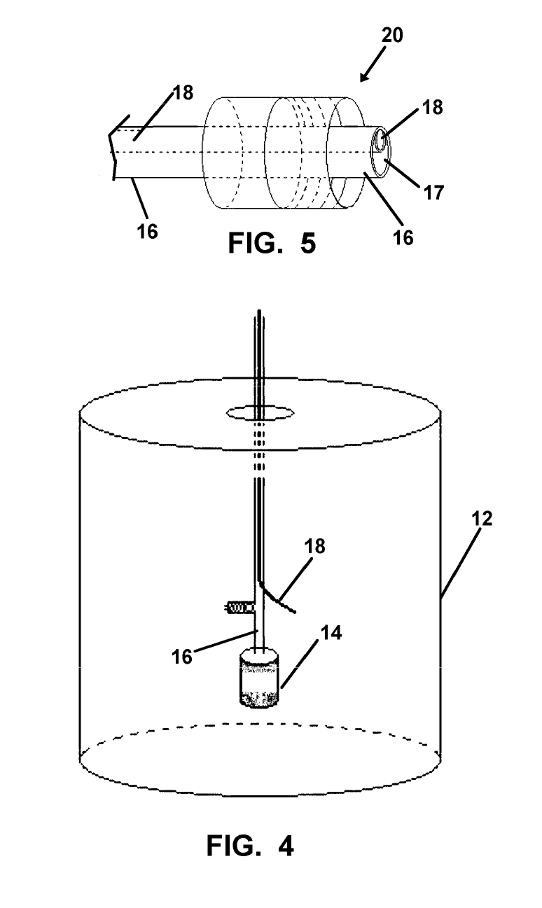

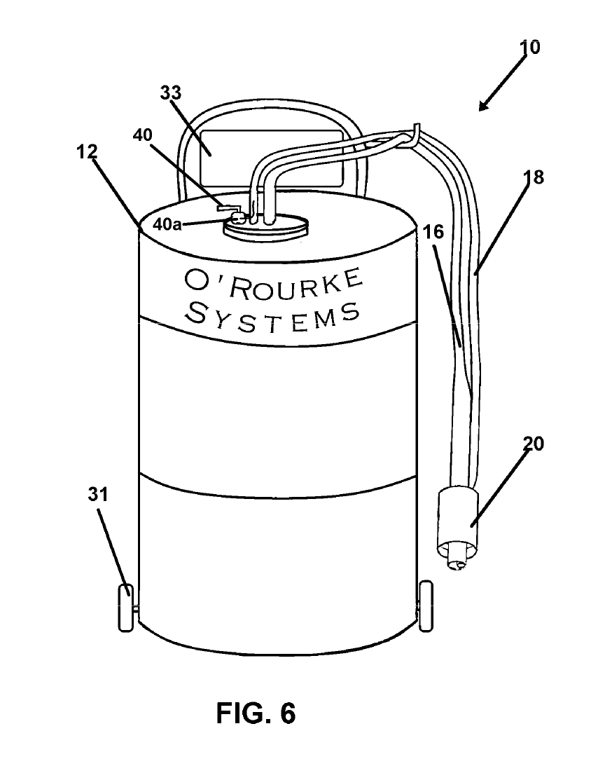

Also depicted in FIG. 1 and other figures herein, is a second tube 18 or conduit which is configured to be employed for venting the vehicle engaged DEF tank of both air and overflowing DEF fluid during a refill thereof. In all modes, the device 10 is configured for engagement to a fluid reservoir 12 with the first end of the first tube 16 submerged in fluid 13a and engaged with a pump 14 and the first end of the second tube 18 extending into the interior cavity 13. The device 10 as shown in FIG. 1 or 4 can be engaged such as shown in FIG. 6, which while showing the device 10 engaged to a reservoir or bottle of DEF fluid, as would be used by a motorist, is essentially the same engagement for a tank reservoir 12 such that the first tube 16 is submerged and engaged to a pump 14 and the second tube 18 extends into the cavity 13.

In FIG. 2 is shown a nozzle end 20 as can be used with all modes of the device 10 herein. Shown is the positioning of the distal end of the first tube 16 in a registered positioning with the second tube 18, and terminating within the axial conduit 17 of the first tube 16, in an off-center position. This off-center positioning of the distal end of the second tube 18 is complimentary to the positioning configuration shown in FIG. 3, where a vent 21 is positioned within a refill opening 23 on a vehicle DEF tank 25. Thus, the nozzle 20 shown in FIG. 2 and employable in all modes of the device 10 herein, is adapted to be easily engaged to fill a vehicle's DEF tank 25 in an easy concurrent engagement of both the distal end of the first hose 16 within the interior circumference of the fill opening 23, and the distal end of the second tube 18, within the inner circumference of the vent 21, in a single easy step.

Also shown in FIG. 2, is a particularly preferred mode of configuration of the device 10 in all modes herein, which includes a pair of one-way or flow-restricting valves which act in concert to restrict the flow of ambient air into the axial passages of both hoses and into the reservoirs 12. The valves 24 and 26, employ the pressurized fluid flow to open and a biasing component to close subsequent to cessation of fluid flow.

As shown, a first one way or flow-restricting valve 24, having a translating sealing member 35 which is held in sealed engagement with a seat 35a by a biasing member 37 shown as a spring, is situated within the axial passage 17 and adjacent the distal end of the first tube 16. This first one-way valve 24 restricts fluid flow in a direct toward the distal end of the first tube 16 which is engaged with the DEF tank 25 (FIG. 3) during the filling operation.

A second one way or flow-restricting valve 26 having a translating member 39 which is by default biased to a sealed engagement against a seat 39a by the biasing member 41, is positioned within the axial passage of the second tube 18, and adjacent the distal end of the second tube 18. Unless translated to an unsealed position by the force of the pressurized flow of escaping gas or fluid from the DEF tank 25, the second one way valve 26 maintains the second tube sealed from ingress of ambient air.

As noted the one-way valves 24 and 26, are both preferred in all modes of the device 10 because upon cessation of the communication of a pressurized fluid or air flow thereto, the valves close to their default position and seal both tubes. This prevents the communication of a continuous or ongoing flow of ambient air into either the first hose 16 or the second hose 18 or into the refill reservoir 12. This sealing the hose lumens helps to substantially eliminate the formation of crystals within the axial passages of the tubes, which occur from the evaporation of water in the mixture of water and urea.

Also shown in FIG. 2 is a fluid sensor 30 which is adapted to sense the presence of DEF fluid within the second tube 18. Upon sensing such a presence, either immediately or after a determined time, the sensor 30, which is in electric communication with a switch to the electric power supply to the pump 14, will open the switch and cease fluid communication through the first hose 16 to the tank. Such switches and sensors are well known in the art and need not be depicted. Employment of the fluid sensor 30 which is in electric communication with a switch to cease the communication of the pressurized fluid flow, provides an automatic shut-off which will be particularly preferred by non professionals such as car owners in filling their own tank.

As noted above, shown in FIG. 3 shows a typical opening for a vehicle DEF tank 25 having a fill opening 23 and vent 21 communicating directly or through conduits leading to the DEF tank. The two openings as noted are offset and in registered positions to those of the first hose 16 and second hose 18 positioned in the offset position therein. This allows a one-step engagement of both hoses with both openings.

FIG. 4 depicts a mode of the device 10 wherein the second hose 18 employed for venting the DEF tank, is positioned to communicate entirely within the lumen or axial conduit 17 of the first hose 16,for the entire length of the first hose 16 outside the DEF refill reservoir 12 and to the nozzle 20 as shown in FIG. 5. This configuration may be a more preferred mode of the device 10 for use by unstrained professionals in the configuration of FIG. 7 since it positions the second hose 18 within the first 16 and the user only has one hose to move about and protect since the second hose 18 is within.

Shown in FIG. 5 is the nozzle end positioning the distal ends of the first hose 16 and second hose 18 of the device in the mode engaging the hoses in the configuration of FIG. 4 terminates at the nozzle end. As can be seen the second hose 18 engages into the first hose 16 within the supply tank, and runs toward the nozzle 20 entirely within the axial conduit 17 of the first hose 16 to their respective distal end registered positions at the distal end of the first hose 16.

Shown in FIG. 6, is a mode of the device 10 using a large drum for the fluid reservoir 12 and positioned on a wheeled cart 31 having an onboard power supply from a battery 33. As in all modes of the device herein, the first hose 16 and second hose 18 are adapted for a sealed engagement with the reservoir 12 with first ends thereof operatively positioned within the reservoir and the first tube engaged with the pump 14. Second or distal ends of both tubes are operatively engaged to the nozzle 20 as noted herein.

A preferred mode of forming this sealed engagement is by connection of both tubes to or through a flange 34, which is adapted to engage a mating fitting surrounding an opening into the reservoir 12. So connected the tubes extend operatively into the reservoir 12, and from the reservoir 12 to engagements of distal ends with the nozzle 20. Both tubes may either simply communication in sealed engagement through the flange 34, or may be engaged to tubes extending from the flange 34 to achieve the sealed flowpaths for both tubes for fluid.

As with other modes shown herein, the nozzle 20 positions both hoses in registered positions to allow a one-step engagement of both the first hose and second hose with their respective sealed engagement with a mating opening and vent.

Also shown is a connector 40 adapted to connect to an electric power supply. The connector 40 is engaged to the pump with insulated electric wires which is well known and need not be shown. Further shown is a switch 40a which may be included and operatively engaged with the sensor 30 to disconnect the communication of electric power from the connector 40 to the pump when fluid is sensed in the second tube by the sensor 30.

FIG. 7 shows an assembled mode of the device 10 where the hoses extending to the nozzle 20 end, are engaged to a flange 34 which is adapted to engage an opening in the top of a bottle or smaller fluid reservoir 12 or can be engaged to the bung hole of a large drum. In this preconfigured mode of the device which is removably engageable to any reservoir 12 having a mating connector to that of the flange 34, both hoses engage with and through the flange 34 configured to engage with an opening of a reservoir 12. The screw on or otherwise engageable flange 34 for example can be configured to engage a threaded spout 36 of the bottle or container reservoir 12 and to position the pump 14 and hoses in the as-used operative positioning within with the fluid reservoir 12.

In this mode the first and second hoses will extend from a lower side of the flange 34 and be automatically positioned within the reservoir 12 when the flange is engaged 34 to the mating opening such as threaded spout 36 or bung hole or the like.

Also shown in this flange 34 engageable mode of the device 10 and applicable to all modes herein, is a connector 40 for the provision of electrical power to the pump 14 which has been positioned within the reservoir 12 by engagement of the flange 34. Power for the pump 14 may be from a DC power supply or vehicle connection such as a cord engaging the cigarette lighter socket available in most vehicles, or from an onboard battery or a power supply engaged with an AC connection.

The connector 40 is operatively engaged to the pump 14 to provide electrical power thereto using wires or other conductors known in the art. Once electric power is engaged to the connector 40 using a mating connector operatively engaged with a battery or electric power source, the pump 14 will provide the pressurized fluid supply to the first hose 16 as long as power is connected. Of course the noted fluid sensor 30 (FIG. 2), can also be included operatively engaged with a switch 40a (FIG. 6) to interrupt communication of electric power to the pump 14, should fluid be sensed within the second tube 18. Further, the first one way valve 24 and second one way valve 26 would also be preferred for inclusion to prevent ongoing communication of ambient air through either hose.

While all of the fundamental characteristics and features of the disclosed DEF refilling device and system have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A refill apparatus for a fluid tank, comprising:
a first hose having an axial conduit communicating between a first end and an opening at a distal end;
a second hose having an axial passage communicating between a first end and a distal end;
said distal end of said first hose and said distal end of said second hose engaged at a nozzle, said nozzle adapted for engagement with a refill opening of said fluid tank with said distal end of said first hose engaged with a refill opening, and said distal end of said second hose engaged with a vent; and
said refill apparatus adapted for engagement with a fluid container having a cavity containing a fluid supply therein, with said first end of said first hose engaged to a pump submerged in said fluid supply, and said first end of said second hose positioned within said cavity, whereby with said nozzle in said engagement with said opening of said fluid tank, a pressurized fluid supply from said pump is communicable to said fluid tank through said first hose, and vented air from said fluid tank during filling by said pressurized fluid supply, is communicated into said second hose.

2. The refill apparatus for a fluid tank of claim 1 wherein said nozzle positioning said distal end of said second hose in a registered position within said axial conduit of said first hose and adjacent said opening; and
said engagement with said refill opening providing a concurrent engagement of said distal end of said first hose with said refill opening and said distal end of said second hose with said vent.

3. The refill apparatus for a fluid tank of claim 1 wherein said refill apparatus is adapted for engagement with said fluid container with a flange;
said flange configured for an engagement upon an opening to said cavity of said reservoir; and
said engagement of said flange upon said opening concurrently positioning said first end of said first hose engaged to a pump which is submerged in said fluid supply and said first end of said second hose positioned within said cavity.

4. The refill apparatus for a fluid tank of claim 2 wherein said refill apparatus is adapted for engagement with said fluid container with a flange;
said flange configured for an engagement upon an opening to said cavity of said reservoir; and
said engagement of said flange upon said opening concurrently positioning said first end of said first hose engaged to a pump which is submerged in said fluid supply and said first end of said second hose positioned within said cavity.

5. The refill apparatus for a fluid tank of claim 3 additionally comprising:
a first one way valve positioned in said axial conduit of said first hose, adjacent said opening at said distal end;
said first one way valve preventing a flow of air into said axial conduit subsequent to cessation of communication of said pressurized fluid supply to said opening.

6. The refill apparatus for a fluid tank of claim 4 additionally comprising:
a first one way valve positioned in said axial conduit of said first hose, adjacent said opening at said distal end;
said first one way valve preventing a flow of air into said axial conduit subsequent to cessation of communication of said pressurized fluid supply to said opening.

7. The refill apparatus for a fluid tank of claim 5 additionally comprising:
a second one way valve positioned in said axial passage of said second hose, at or adjacent said second end thereof;
said second one way valve preventing a flow of air into said axial passage, subsequent to cessation of venting of air from said fluid tank.

8. The refill apparatus for a fluid tank of claim 6 additionally comprising:
a second one way valve positioned in said axial passage of said second hose, at or adjacent said second end thereof;
said second one way valve preventing a flow of air into said axial passage, subsequent to cessation of venting of air from said fluid tank.

9. The refill apparatus for a fluid tank of claim 5 additionally comprising:
an electrical connector positioned on said flange said electrical connector operatively engaged with said pump to communicate electric power thereto; and
said electrical connector adapted to connect to an electric power supply.

10. The refill apparatus for a fluid tank of claim 6 additionally comprising:
an electrical connector positioned on said flange said electrical connector operatively engaged with said pump to communicate electric power thereto; and
said electrical connector adapted to connect to an electric power supply.

11. The refill apparatus for a fluid tank of claim 7 additionally comprising:
an electrical connector positioned on said flange said electrical connector operatively engaged with said pump to communicate electric power thereto; and
said electrical connector adapted to connect to an electric power supply.

12. The refill apparatus for a fluid tank of claim 8 additionally comprising:
an electrical connector positioned on said flange said electrical connector operatively engaged with said pump to communicate electric power thereto; and
said electrical connector adapted to connect to an electric power supply.

13. The refill apparatus for a fluid tank of claim 11 additionally comprising:
a fluid sensor positioned within said axial passage in-between said second one way valve and said first end of said second tube, said fluid sensor emitting a signal upon sensing liquid within said axial passage; and
a switch, said switch interrupting said electrical power supply to said pump upon receipt of said signal from said fluid sensor.

15. The refill apparatus for a fluid tank of claim 12 additionally comprising:
a fluid sensor positioned within said axial passage in-between said second one way valve and said first end of said second tube, said fluid sensor emitting a signal upon sensing liquid within said axial passage; and
a switch, said switch interrupting said electrical power supply to said pump upon receipt of said signal from said fluid sensor.
